(19) United States
(12) Patent Application Publication
(10) Pub. No.: US 2016/0269261 A1
(43) Pub. Date: Sep. 15, 2016

(54) SYSTEM AND METHOD FOR MATCHING ELECTRONIC DEVICES FOUND BY MULTIPLE TOOLS

(71) Applicant: ECI Solutions, Inc., Fort Worth, TX (US)

(72) Inventors: David R. Webb, Landera Ranch, CA (US); Kevin Tetu, Mesa, AZ (US)

(73) Assignee: ECI Solutions, Inc, Forth Worth, TX (US)

(21) Appl. No.: 14/643,101

(22) Filed: Mar. 10, 2015

(51) Int. Cl. H04L 12/26; H04L 29/08

(52) U.S. Cl. CPC H04L 43/10; H04L 67/10

(57) ABSTRACT

A system and method for matching electronic devices found by multiple collection tools. The collection tools may be configured to obtain identical identification information regarding the same electronic device, but also to obtain other types of information dissimilar from each other regarding the same electronic device. Matching content of the identification information fields for the different collection tools allows a user to review the other dissimilar fields of data collected by these collection tools and determine if they are associated with the same electronic devices or different electronic devices.

### BACKGROUND

Network-connected devices such as printers, copiers, and fax or facsimile machines may need to be monitored for maintenance purposes and/or other tracking purposes. For example, in some offices, tracking the number of pages printed and with which projects those pages are associated may be important for billing purposes. A number of existing collection tools, such as different computer software and hardware devices, are capable of auditing such networked devices, either on site or remotely via wired or wireless network communication.

Different collection tools may be made and/or used by different manufacturers or dealers. Each of the collection tools may collect different sets of data. Even when the same data field is collected from the same network-connected device, it may be collected differently and return a different result. When processing data collected by different collection tools, it can be difficult to determine if the same network-connected device was discovered by each of two or more of the collection tools. If the collected data is not properly matched to the same network-connected device, the combined data may incorrectly represent the number and types of network-connected devices that are present.

### SUMMARY OF THE INVENTION

Embodiments of the present invention solve the above-mentioned problems and provide a distinct advance in the art of matching electronic devices found by multiple collection tools.

One embodiment of the invention may include a system comprising one or more physical, non-transitory computer-readable storage mediums with executable programs stored thereon for collecting data from electronic devices. The programs may include a first collection tool module and a second collection tool module. The first collection tool module may include a code segment for collecting content for a first set of data fields regarding a first electronic device using a first process and a code segment for collecting content for a second set of data fields regarding the first electronic device using a second process. The second collection tool module may include a code segment for collecting content for the first set of data fields regarding the first electronic device using the first process, and a code segment for collecting content for a third set of data fields regarding the first electronic device using the second process or a third process. The system may further include a code segment for associating contents of the second set of data fields and contents of the third set of data fields with the first electronic device when contents of the first set of data fields collected by the first and second collection tool modules match.

Another embodiment of the invention is a method for collecting and matching data regarding electronic devices using a plurality of different collection tools. This method may include the steps of collecting, with a first collection tool, content for a first set of data fields regarding a first electronic device using a first process and content for a second set of data fields regarding the first electronic device using a second process. The method may then include a step of comparing content collected by the first collection tool for the first set of data fields with content collected by a second collection tool for the first set of data fields stored in a database. The content collected by the second collection tool for the first set of data fields may be associated in the database with content collected by the second collection tool for a third set of data fields. Finally, the method may include a step of associating content from the third set of data fields and content from the second set of data fields with the first electronic device in the database when content collected by the first collection tool for the first set of data fields matches content collected by the second collection tool for the first set of data fields.

Another embodiment of the invention includes a method for collecting and matching data regarding electronic devices using a plurality of different collection tools. The electronic devices may be network-connected devices including printers, copiers, facsimile machines, and functional peripheral devices. The method may include the steps of collecting, with a first collection tool, content for a first set of data fields regarding a first electronic device using a first process and content for a second set of data fields regarding the first electronic device using a second process. Furthermore, the method may include the steps of collecting, with the first collection tool, content for the first set of data fields regarding a second electronic device using the first process and content for the second set of data fields regarding the second electronic device using the second process. The method may also include collecting, with a second collection tool, content for the first set of data fields regarding the first electronic device using the first process, content for a third set of data fields regarding the first electronic device using a third process, content for the first set of data fields regarding the second electronic device using the first process, and content for the third set of data fields regarding the second electronic device using the third process. The method may further include a step of comparing content collected by the first collection tool for the first set of data fields with content collected by the second collection tool for the first set of data fields. Finally, the method may include a step of associating content from the third set of data fields and content from the second set of data fields with either the first electronic device or the second electronic device in a database based on matching contents of the first set of data fields collected by the first and second collection tools.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic view of a data collection system constructed according to embodiments of the present invention;

FIG. 2 is a table listing prior art data fields collected by two dissimilar collection tools;

FIG. 3 is a table listing data fields collected by two dissimilar collection tools in accordance with embodiments of the present invention; and

FIG. 4 is a flow chart illustrating a method of collecting and matching data regarding electronic devices using a plurality of different collection tools in accordance with embodiments of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

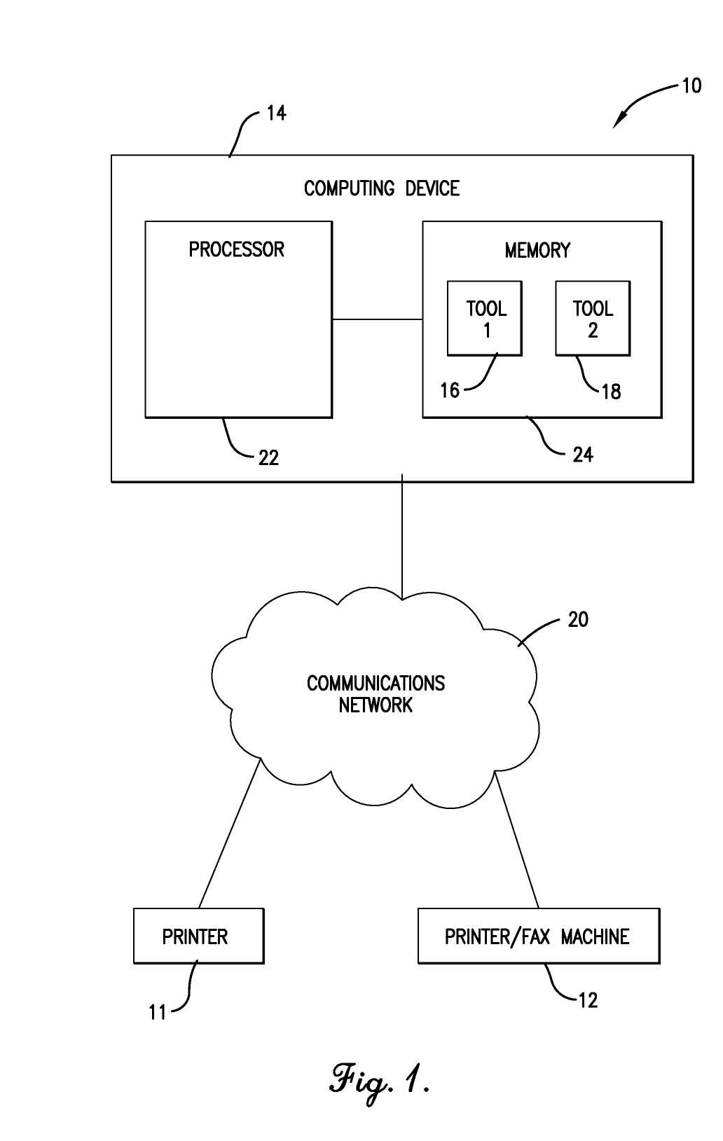

A data collection system 10 in accordance with the present invention is illustrated in FIG. 1, along with a plurality of electronic devices 11,12 to be monitored, tracked, and/or audited by the data collection system 10. The term “electronic devices,” as used herein, may include printers, copiers, facsimile machines, and functional peripheral devices, and any network-connected devices known in the art. The data collection system 10 may comprise one or more computing devices 14, including a plurality of collection tools 16,18, which may be implemented in different types of device monitoring software and/or hardware. The data collection system 10 may further comprise a communication network 20 and/or other communication devices for communicating with electronic devices 12. The collection tools 16,18 may be configured to obtain identical identification information regarding the same electronic device 11, but also to obtain other types of information dissimilar from each other regarding the same electronic device 11.

In some embodiments of the invention, the collection tools 16,18 may be collection tool modules comprising computer-executable code configured for performing one or more of the method steps described herein. Specifically, each of the collection tools 16,18, computing devices 14, electronic devices 11,12, user computers, or various networked devices described herein, may include and/or be implemented on a processor 22 and included and/or be stored on a computer-readable medium 24 residing thereon or communicably coupled therewith. One or more computer programs may be stored in or on the computer-readable medium(s) 24 and may be configured for being executed by the processor(s) 22. The computer programs may comprise listings of executable instructions for implementing logical functions in the processor 22 and/or other devices communicably coupled therewith and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium 24 can be, for example, but not limited to, an electronic, magnetic, optical, electro-magnetic, infrared, or semi-conductor system, apparatus, or device. More specific, although not inclusive, examples of the computer-readable medium 24 would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The communication network 20, as illustrated in FIG. 1, generally allows communication between the collection devices 16,18 and the electronic devices 11,12 being monitored, tracked, and/or audited thereby. The communication network 20 may also allow the electronic devices 11,12 to communicate with each other and/or with other computers or peripheral devices. For example, the communication network 20 may allow a printer to communicate with a user computer or the like. The communication network 20 may include local area networks, metro area networks, wide area networks, cloud networks, the Internet, or the like, or combinations thereof. The communication network 20 may also include or connect to voice and data communication systems such as cellular networks and public ordinary telephone systems. The communication network 20 may be wired, wireless, or combinations thereof and may include components such as switches, routers, hubs, access points, and the like. The collection tools 16,18 may connect to the communication network 20 either through wires, such as electrical cables or fiber optic cables, or wirelessly using any wireless communications protocols known in the art.

In some embodiments of the invention, both a first collection tool 16 and a second collection tool 18 may be used to collect identification information regarding a plurality of the electronic devices 11,12, such as various network-connected devices, peripheral devices, printers, facsimile machines, copiers, and the like. The collection tools 16,18 may each be programmed to collect the same identification information in the same way, using the same processes to collect the same data fields. Those data fields may include identification information such as a device identifier, device manufacturer, device model, device serial number, network address of the local processor, and the like. For example, as illustrated in FIG. 3, the identification information may be collected and stored under the following field names: manufacturer, model, serial number, MAC address, IP address, host name, local ID, etc. However, each of the collection tools 16,18 may additionally collect one or more fields of dissimilar information using the same or different processes.

The dissimilar types of data collected by the collection tools 16,18 could be any type of information monitored, tracked, and/or audited for a given electronic device 11,12. For example, the dissimilar types of data could include any combination of the any of the following data fields: device description, device location, life-time meter read of the electronic device, mono meter read of the electronic device, color meter read of the electronic device, printer pages meter read, fax pages meter read, copy pages meter read, list pages meter read, life-time scan meter read, fax scan meter read, copy scan meter read, scan to network processor meter read, email scan meter read, toner coverage read, low paper indicator, no paper indicator, low toner indicator, no toner indicator, door open indicator, jammed indicator, offline indicator, service requested indicator, printed document identifiers (i.e. who printed), the type of paper (drawer, source, color, size, etc.), the number of page, the date and time of printing, the document name, the user department code, and combinations thereof.

In some embodiments of the invention, the first collection tool 16 may obtain user data while the second collection tool 18 may obtain device data. For example, user data may be data output by a computer operating the first electronic device 11 (such as a user computer sending print job information to the first device), while device data may be data output directly from the first electronic device 11 (such as the number of copies a printer output, toner level, error notifications, etc.). In some embodiments of the invention, the device data and the user data may be collected by separate software on separate ones of the computing devices 14. However, in other embodiments of the invention, the device data and the user data may be collected by separate software on a same one of the computing devices 14 which is connected via the communication network 20 to one or more of the electronic devices 11,12 being monitored.

Some examples of collection tools 16,18 known in the art may include data collectors such as FMAUDIT ONSITE from ECi Software Solutions, Inc. of Fort Worth, Tex. for gathering device data and ROI PRINT MANAGER from Print Control Software, Inc. of Scottsdale, Ariz. for collecting user data. In one embodiment of the invention, one or more of the collection tools 16,18 may be constructed and operated in accordance with the status monitoring system and methods described in U.S. Pat. No. 8,825,835, incorporated by reference herein in its entirety. Additionally or alternatively, the collection tools 16,18 may include software by a variety of manufacturers.

In use, the first collection tool 16 may collect content for a first set of data fields 26 regarding the first electronic device 11 using a first process and may collect content for a second set of data fields 28 regarding the first electronic device 11 using a second process. Likewise, the second collection tool 18 may collect content for the first set of data fields 26 regarding the first electronic device 11 using the first process and may collect content for a third set of data fields 30 regarding the first electronic device 11 using the second process or a third process.

The first set of data fields 26 may be associated with identification information about the first electronic device 11, the second set of data fields 28 may be associated with device data or any other type of data, and the third set of data fields 30 may be associated with user data or any other type of data. These same data fields may be collected by any plurality of collection tools 16,18 for any plurality of electronic devices 11,12.

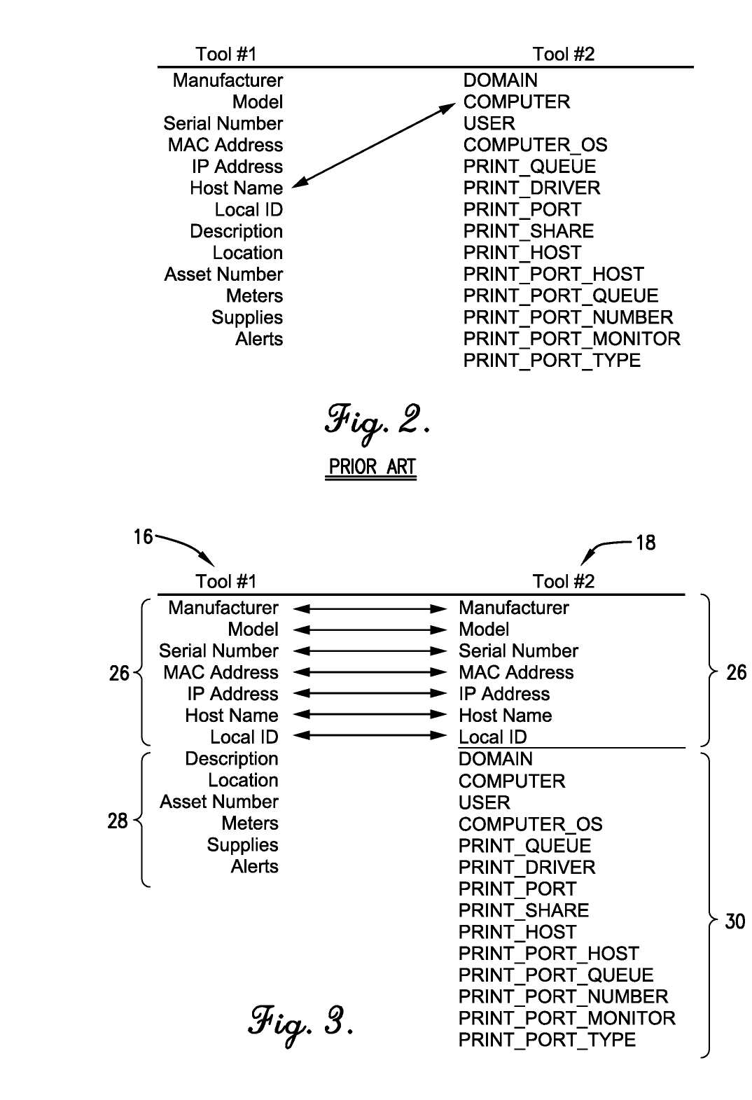

FIG. 3 provides a table illustrating the set of data fields 26-30 collected by the first and second collection tools, and shows the electronic device's identification information listed first using an identical common core code. This allows matching of information belonging to the same electronic device but collected by different tools. Contrast this with the prior art table of FIG. 2, illustrating dissimilar fields collected by different collection tools for the same electronic device.

Advantageously, because each of the collection tools 16,18 collects the first set of data fields 26 using an identical process, matching content in these fields of data allows a user or other analysis tools (such as computer code executed on one of the computing devices 14) to review the data obtained by multiple collection tools and determine if they are associated with the same electronic devices 11,12 or different electronic devices 11,12. This ensures an accurate representation of the number and type of electronic devices 11,12 (e.g., printers, etc.) that are present in a given office or on a given network.

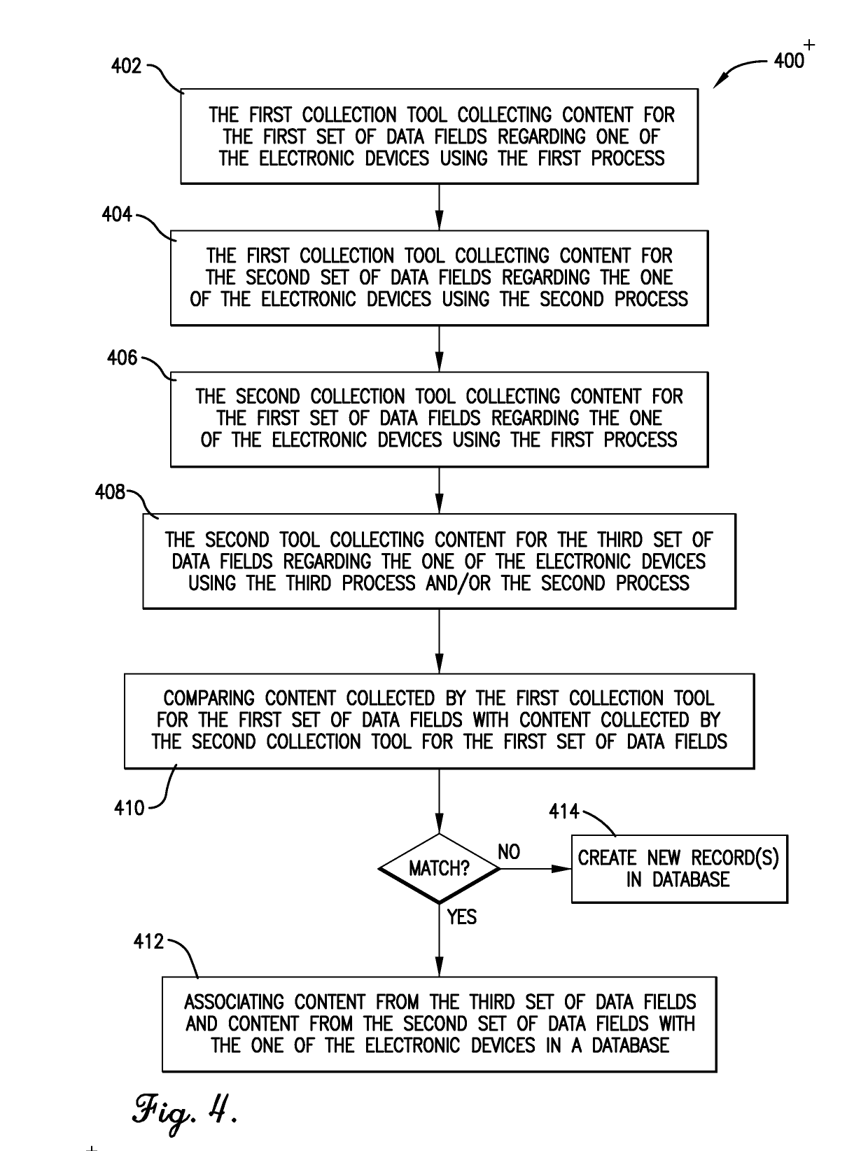

Method steps for collecting and matching data regarding electronic devices 11,12 using a plurality of different collection tools 16,18 will now be described in more detail, in accordance with various embodiments of the present invention. The steps of the method 400 may be performed in the order as shown in FIG. 4, or they may be performed in a different order. Furthermore, some steps may be performed concurrently as opposed to sequentially. In addition, some steps may not be performed. Some of the steps may represent code segments or executable instructions of the computer program or tools described above.

The method 400 may include a step of collecting, with the first collection tool 16, content for the first set of data fields 26 regarding one of the electronic devices 11,12 using the first process, as depicted in block 402. As noted above, the first set of data fields 26 may include identification information for the electronic device being monitored, such as manufacturer, model, serial number, MAC address, IP address, host name, local ID, etc.

Next, the method 400 may include a step of collecting, with the first collection tool 16, content for the second set of data fields 28 regarding the one of the electronic devices 11,12 using the second process noted above, as depicted in block 404. Again, as noted above, the second set of data fields 28 may include user data and/or devices data regarding one of the electronic devices 11,12, such as number of copies, toner level, print job information, etc.

The method 400 may further include the steps of collecting, with the second collection tool 18, content for the first set of data fields 26 regarding the one of the electronic devices 11,12 using the first process, as depicted in block 406, and collecting, with the second collection tool 18, content for the third set of data fields 30 regarding the one of the electronic devices 11,12 using the third process and/or the second process, as depicted in block 408. As with the second set of data fields 28, the third set of data fields 30 may include user data, device data, and/or other types of data regarding one of the electronic devices 11,12, as described above.

In some embodiments of the invention, the second set of data fields 28 is different than the third set of data fields 30 and/or the second process is different than the third process, such that different values could be returned for identical data fields for the same electronic device 11,12. Additionally or alternatively, the second set of data fields 28 and the third set of data fields 30 may be stored and/or collected in a different sequence from each other.

In one embodiment of the invention, the first collection tool 16 may collect the device data and the second collection tool 18 may collect the user data. Thus, the second set of data fields 28 may be associated with device data and the third set of data fields 30 may be associated with user data. As described above, the user data may be output by a computer operating or commanding the electronic devices 11,12 and the device data may be output directly from the first or second electronic device 11,12.

In some embodiments of the invention, the data collected by the second collection tool 18 may already be stored in a database along with a plurality of other data corresponding to any plurality of electronic devices. Specifically, the collection steps 406 and 408 may have been performed by another device or user at any time prior to the other steps of method 400 and may therefore be omitted without departing from the scope of the invention.

The method 400 may also include a step of comparing content collected by the first collection tool 16 for the first set of data fields 26 with content collected by the second collection tool 18 for the first set of data fields 26, as depicted in block 410. This step may further include comparing the data collected by the first collection tool 16 for the first set of data fields 26 with any plurality of data in a database to determine if a match exists in the previously collected data. In the example embodiments described herein, a match is found with the content collected by the second collection tool 18 for the first set of data fields 26. However, any stored content for the first set of data fields 26 may be found to match content for the first set of data fields 26 collected by the first collection tool 16 without departing from the scope of the invention.

Based on results of the comparison step in block 410, the method 400 then includes a step of associating content from the third set of data fields 30 and content from the second set of data fields 28 with the one of the electronic device 11,12 in the database when content collected by the first collection tool 16 for the first set of data fields 26 matches content collected by the second collection tool 18 for the first set of data fields 26, as depicted in block 412. For example, when a match is found in the database between the content of the first set of data fields collected by the first collection tool 16 and that stored in a record on the database, the record may be updated. If no match was found, a new record may be created and stored in the database, as depicted in block 414. The comparison and associating steps may be performed by a user manually and/or in an automated fashion via computer code executed on at least one of the computing devices 14.

In some embodiments of the invention, the method 400 may repeat various ones of the collecting, comparing, and associating steps for a plurality of other electronic devices, as depicted in block 414. Specifically, the collection steps above may be repeated for a plurality of the electronic devices 11,12, such as all of the electronic devices 11,12 connected in a network or in a particular office or selected area. Furthermore, more than two collection tools 16,18 may be used to perform the collection steps described above, with more dissimilar data fields than described herein, without departing from the scope of the invention. The content collected by all of these collection tools 16,18 may be matched according to the first set of data fields 26 collected for each of the collection tools 16,18, regardless of the dissimilar nature of the remaining fields for which they gather information.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system comprising one or more physical, non-transitory computer-readable storage mediums with executable programs stored thereon for collecting data from electronic devices, the programs comprising:
a first collection tool module including:
a code segment for collecting content for a first set of data fields regarding a first electronic device using a first process, and
a code segment for collecting content for a second set of data fields regarding the first electronic device using a second process; and
a second collection tool module including:
a code segment for collecting content for the first set of data fields regarding the first electronic device using the first process, and
a code segment for collecting content for a third set of data fields regarding the first electronic device using the second process or a third process; and
a code segment for associating contents of the second set of data fields and contents of the third set of data fields with the first electronic device when contents of the first set of data fields collected by the first and second collection tool modules match.

2. The computer-readable storage mediums of claim 1, wherein the first electronic device is a local or network-connected device including at least one of printers, copiers, facsimile machines, and functional peripheral devices.

3. The computer-readable storage mediums of claim 1, wherein the first set of data fields includes identifying information about the electronic devices.

4. The computer-readable storage mediums of claim 1, wherein the second set of data fields is different than the third set of data fields or the second set of data fields is collected by a different process than the third set of data fields.

5. The computer-readable storage mediums of claim 1, further comprising a code segment for comparing the contents of the first set of data fields collected by the first collection tool module with contents of the first set of data fields collected by the second collection tool module, and determining when contents of the first set of data fields collected by the first and second collection tool modules match.

6. The system of claim 1, wherein the first set of data fields includes at least one of manufacturer, model, serial number, MAC address, IP address, host name, and local ID.

7. The system of claim 1, wherein the first collection tool is configured to collect content from device data and the second collection tool is configured to collect content from user data, wherein the user data is content received from a computer operating the first electronic device and the device data is content received directly from the first electronic device.

8. The method of claim 7, wherein the first set of data fields is associated with identification information about the first electronic device, the second set of data fields is associated with device data, and the third set of data fields is associated with user data.

9. The system of claim 1, wherein the first and second collection tool modules each further comprise code segments for collecting content for the first set of data fields and content for one or more data fields dissimilar from each other regarding a second electronic device.

10. A method for collecting and matching data regarding electronic devices using a plurality of different collection tools, the method comprising the steps of:
collecting, with a first collection tool, content for a first set of data fields regarding a first electronic device using a first process;
collecting, with the first collection tool, content for a second set of data fields regarding the first electronic device using a second process;
comparing content collected by the first collection tool for the first set of data fields with content collected by a second collection tool for the first set of data fields stored in a database, wherein the content collected by the second collection tool for the first set of data fields is associated in the database with content collected by the second collection tool for a third set of data fields; and associating content from the third set of data fields and content from the second set of data fields with the first electronic device in the database when content collected by the first collection tool for the first set of data fields matches content collected by the second collection tool for the first set of data fields.

11. The method of claim 10, wherein the content collected for the third set of data fields with the second collection tool was collected using a different process than the second process.

12. The method of claim 10, wherein the first set of data fields is associated with identification information about the first electronic device, the second set of data fields is associated with device data or user data, and the third set of data fields is associated with device data or user data, wherein the user data is output by a computer operating the first electronic device and the device data is output directly from the first electronic device.

13. The method of claim 10, further comprising repeating each of the collecting, comparing, and associating steps for content regarding a second electronic device.

14. The method of claim 10, wherein the first collection tool and the second collection tool include one or more computers or other devices having a processor configured to access a computer-readable medium and execute one or more computer programs stored thereon, wherein the computer programs include code segments for performing the collecting, comparing, and associated steps.

15. The method of claim 10, wherein the electronic devices are local or network-connected devices including at least one of printers, copiers, facsimile machines, and functional peripheral devices.

16. The method of claim 10, wherein the second set of data fields is different than the third set of data fields.

17. A computer-implemented method for collecting and matching data regarding printers using a plurality of different collection tools, the method comprising the steps of:
collecting, with a first collection tool, printer identification information for a first set of data fields regarding a first printer using a first process;
collecting, with the first collection tool, printer or print job status information for a second set of data fields regarding the first printer using a second process;
collecting, with the first collection tool, printer identification information for the first set of data fields regarding a second printer using the first process;
collecting, with the first collection tool, printer or print job status information for the second set of data fields regarding the second printer using the second process;
collecting, with a second collection tool, printer identification information for the first set of data fields regarding the first printer using the first process;
collecting, with the second collection tool, printer or print job status information for a third set of data fields regarding the first printer using a third process;
collecting, with the second collection tool, printer identification information for the first set of data fields regarding the second printer using the first process;
collecting, with the second collection tool, printer or print job status information for the third set of data fields regarding the second printer using the third process;
comparing printer identification information collected by the first collection tool for the first set of data fields with printer identification information collected by the second collection tool for the first set of data fields; and
associating printer or print job status information from the third set of data fields and printer or print job status information from the second set of data fields with either the first printer or the second printer in a database based on matching printer identification information of the first set of data fields collected by the first and second collection tools.

18. The method of claim 17, wherein printer or print job status information collected in the second set of data fields is associated with device data, and the printer or print job status information collected in the third set of data fields is associated with user data, wherein the user data is print job information collected from a computer operating the printers and the device data is information collected directly from the printers regarding print jobs and printer status information.

19. The method of claim 17, wherein the first collection tool and the second collection tool include one or more computers or other devices having a processor configured to access a computer-readable medium and execute one or more computer programs stored thereon, wherein the computer programs include code segments for performing the collecting, comparing, and associating steps.

20. The method of claim 17, wherein the second set of data fields is different than the third set of data fields or the second set of data fields is collected or stored in a different sequence or collected by a different process than the third set of data fields.
